(19) United States
(12) Patent Application Publication
(10) Pub. No.: US 2006/0108013 A1
(43) Pub. Date: May 25, 2006

(54) Condensate trap

(76) Inventor: Richard Quentin Carmichael, Gloucestershire (GB)

Correspondence Address: DUANE MORRIS, LLP;IP DEPARTMENT, 30 SOUTH 17TH STREET, PHILADELPHIA, PA, 19103-4196, US

(21) Appl. No.: 10/541,717

(22) PCT Filed: Jan. 12, 2004
(86) PCT No.: PCT/GB04/00094

§ 371 Date: Oct. 24, 2005

(30) Foreign Application Priority Data
Jan. 13, 2003 (GB) 0300716.8

(51) Int. Cl. F15C 1/16

(52) U.S. Cl. 137/809

(57) ABSTRACT

A steam trap (1) is provided comprising a chamber (8) having a substantially cylindrical sidewall, an inlet 20 provided towards the upper end of the sidewall, and an escape aperture (16) provided at its base. The inlet (20) introduces the fluid into the chamber (8) in a manner to promote a rotational flow of the fluid in the chamber (8), so as to create a low pressure location upstream of the escape aperture (16) to restrict the discharge rate of the aperture (16).

### FIELD OF THE INVENTION

This invention relates to condensate traps.

### BACKGROUND OF THE INVENTION

Condensate traps are commonly employed to remove condensed water from steam utilizing plant and equipment, in which context they are normally referred to as steam traps. Many different designs of steam traps have been developed to suit a variety of circumstances. The majority of traps involve a self-actuating mechanism which detects the presence of condensate in the trap, and when necessary opens to allow the condensate to drain. These traps have moving parts and consequently are prone to suffering mechanical failure. An alternative form of trap is a fixed orifice trap. These are generally reliable as they have no moving parts, and in the simplest form comprise an aperture through which condensate is discharged. Flash steam produced as the pressure drops during flow through the aperture acts to reduce the amount of steam that escapes through the aperture.

One problem encountered with fixed orifice traps is that the aperture may become blocked. A further problem is that it is difficult to select an orifice size which matches the condensate load exactly, so that condensate is discharged while preventing live steam from leaking through the aperture. In reality fixed orifice traps tend to be oversized to ensure that condensate is effectively removed while the consequent loss of steam, when little or no condensate is present, is accepted.

### SUMMARY OF THE INVENTION

According to a first aspect of the present invention there is provided a condensate trap comprising a vortex chamber, an inlet being provided for admitting fluid into the chamber in a manner to promote a rotational flow of the fluid in the chamber about a longitudinal axis of the chamber, and an escape aperture being provided at an axial end of the chamber.

Preferably at least a portion of the side wall has a substantially circular cross section and may be cylindrical. In one embodiment, the cylindrical portion adjoins the wider diameter end of a frusto conical portion. The escape aperture may be provided at the narrower end of the frusto conical portion, for example on the longitudinal axis of the chamber.

The chamber may have a circular transverse end wall, the escape aperture being provided in the centre of the end wall.

In a practical embodiment of a steam trap in accordance with the present invention, the vortex chamber may be provided in a control element supported by a body provided with inlet and outlet passages which communicate respectively with the inlet to the chamber and the escape aperture. The body may be provided with means for connecting the inlet and outlet passages to pipework of a steam utilisation plant.

The control element and the body may abut each other at respective contact surfaces, which are preferably flat and circular. Ports are preferably then provided at the contact surfaces to provide communication between the inlet and outlet passages in the body and the respective inlet and escape aperture in the control element.

The control element may be engageable with the body at the contact surfaces in any one of a plurality of different rotational positions, for example if the contact surfaces are circular as mentioned above. The port communicating with the escape aperture may serve as the centre of rotation between the different rotational positions. To ensure communication between the inlet passage and the inlet in all possible rotational positions, the port communicating with the inlet may take the form of a circular groove centred on the port communicating with the escape aperture.

The inlet may be one of a plurality of inlets, for example three inlets, which are equally distributed around the chamber and which are directed tangentially of the chamber to induce the vortex.

The control element may be secured to the body by means of a cap, which clamps the control element to the contact surface of the body. The chamber may open at a face of the control element opposite the contact surface, in which case the cap preferably closes the chamber.

A second inlet may be provided, which directs the fluid towards the central longitudinal axis of the chamber.

The second inlet may be provided at the same longitudinal portion along the vortex chamber as the first inlet. Switch means may be provided to select either the first or second inlet to introduce the fluid into the chamber. The switch means may be responsive to temperature sensing means, such as a bimetallic strip, which senses the temperature of the fluid upstream of the trap.

The escape aperture may have any suitable diameter, depending on the required discharge rate of condensate. In most circumstances, it is envisaged that the escape aperture diameter will fall in the range 1 mm to 40 mm, although in many embodiments the escape aperture diameter will be less than 30 mm, and possibly less than 10 mm. For example, the diameter of the escape aperture may be 5 mm.

According to a second aspect of the present invention, there is provided a method of reducing a flow of steam through an escape aperture of a steam trap, comprising the steps of:
directing a fluid comprising a mixture of steam and condensate into a chamber in a direction so as to create a vortex within the chamber, and
providing the escape aperture directly downstream of a low pressure location within the vortex.

### BRIEF DESCRIPTION OF THE DRAWINGS

For a better understanding of the present invention, and to show more clearly how it may be carried into effect, reference will now be made, by way of example, to the accompanying drawings, in which:—

FIG. 1 is a cross section view of a fixed orifice steam trap in accordance with a first embodiment of the present invention;

FIG. 2 is a plan view of the fixed orifice steam trap of FIG. 1 as viewed from the line II-II in FIG. 1;

FIG. 3 is a cross section view of a fixed orifice steam trap in accordance with a second embodiment of the present invention;

FIG. 4 is a plan view of the fixed orifice steam trap of FIG. 3 as viewed from the line IV-IV in FIG. 3;

FIG. 5 is a sectioned view of another embodiment of a steam trap;

FIG. 6 is a plan view of the steam trap of Figure; and

FIG. 7 is a plan view of a component of the steam trap of FIGS. 5 and 6.

### DETAILED DESCRIPTION

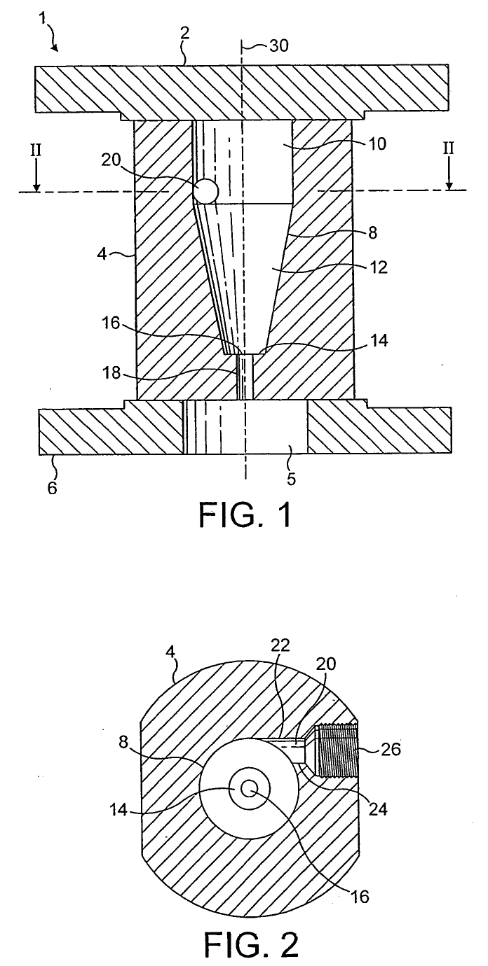

With reference to FIG. 1, the steam trap 1 comprises an upper flange 2, a lower flange 6, and a main body 4 secured between the upper and lower flanges 2,6.

The body 4 defines a vortex chamber 8, having an upper portion 10 and a lower portion 12. The upper portion 10 of the vortex chamber is cylindrical and closed off at its upper edge by the upper flange 2. The lower portion is a conical frustum, continuing from the cylindrical wall of the upper portion 10 and tapering to a smaller diameter at its flat base 14. An escape aperture 16 is provided in the centre of the base 14 on the central axis 30 of the trap 1, leading to a conduit 18 extending vertically downwardly from the aperture 16. The escape aperture 16 is approximately 5 mm diameter in this example. This communicates at its lower opening to the surrounding environment or to a condensate return pipe (not shown), via a circular opening 5 in the lower flange 6.

The conduit 18 has a length which is greater than the diameter of the escape aperture, for example greater than twice the diameter of the escape aperture. In the embodiment shown, the length of the conduit 18 is 12 mm.

A substantially cylindrical inlet passage 20 is provided in the main body 4, and opens into the wall of the chamber 8 at the lower region of the upper portion 10 of the chamber 8. Referring now to FIG. 2, the outermost edge 22 of the cylindrical inlet passage 20 continues tangentially from the cylindrical wall of the chamber 8. The innermost edge 24 of the inlet passage 20 is offset from the central axis 30 of the chamber 8 towards the outer edge 22. At the end of the inlet 20 away from the chamber 8, a connector 26 is provided to connect the inlet 20 to a source of steam and condensate.

In use, steam and condensate is introduced tangentially into the chamber 8 through the inlet 20. With the inlet 20 oriented as shown in FIG. 2, the steam and condensate flows around the chamber wall 8 in an anticlockwise direction, creating a vortex. The central axis of the vortex lies on or close to the central axis 30 of the chamber 8.

The vortex naturally generates a low pressure at its centre. As the escape aperture 14 is located on the central axis 30, the vortex thus provides a low pressure region directly upstream of the aperture 16. This reduces the discharge rate through the escape aperture, and accordingly a larger escape aperture can be used, reducing the likelihood of the aperture becoming blocked. Additionally, the self regulatory mechanisms of the vortex provide increased condensate discharge in relation to the discharge of steam leaking from the aperture, as the trap exhibits the following characteristics:

During plant start up, cold condensate is built up throughout the system and the condensate load on the trap is at its highest at this time. As the water is cold, little or no flash steam will be created, as the water is typically not near the steam saturation temperature and so will not flash to steam at the pressures encountered, either at the low pressure centre of the vortex, or at pressure of the outside environment. Therefore the cold water will flow freely through the escape aperture 16.

However, as the temperature at the steam trap increases, the water will eventually reach the saturation temperature for the pressure prevailing at the centre of the vortex. At this point vapour or flash steam will begin to form, and it is this flash steam that will be expelled through the escape aperture 16. This has the effect of reducing the discharge through the escape aperture 16, as the density of the flash steam is much lower than that of water.

The low pressure created at the centre of the vortex also reduces the pressure drop from upstream to downstream of the escape aperture 16. Therefore this will also reduce the discharge rate of the aperture 16 as an effect additional to the creation of flash steam as described above.

The flow in the trap is in practice very complex. In accordance with the present invention the vortex chamber creates an area of low pressure upstream of the escape aperture. As is well known in the art, in a vortex pressure energy is converted to kinetic energy. From the conservation of energy (Bernoulli) equation, as the velocity increases the pressure falls. Therefore, low pressure results in low density at any given point, in this case the centre of the vortex. By creating this condition, as steam reaches the escape orifice, the mass discharge rate is reduced in accordance with the flow equation for a single phase fluid:
Q=C_{d}×(πd²/4)×√(ρ×Δp_{c})
where
Q=flow rate
C_{d}=discharge coefficient
d=orifice diameter
ρ=fluid density
Δp_{c}=critical pressure drop

Since the density of water at 20° C. is 998 kg/m³ and the density of steam at 5 barg is 3.2 kg/m³, the ratio of the mass discharge rates of steam and water is:

$$\sqrt{\frac{{ρ}_{w}}{{ρ}_{s}}} = \sqrt{\frac{998}{3.2}} = 17.7$$

Thus, when flash steam is generated just upstream of the escape aperture 16, the mass discharge rate of the steam is smaller than that of water by a factor of more than 17.

In tests, it has been shown that, for a steam line pressure of 11 bar (ie the pressure at the inlet 20), the pressure falls to 7 bar at the centre of the vortex. At 7 bar, the saturation temperature is 165°, and so if the temperature of the condensate entering the trap falls below 165° C., no flash steam is generated and the condensate is discharged rapidly. Above this temperature the volume of flash steam generated will steadily increase, progressively reducing the rate of discharge of the escape aperture 16. It has been found that the mass rate of discharge falls to 50% of its initial (cold water) value as the condensate temperature increases from ambient temperature to near saturation temperature.

Therefore a fixed orifice trap in accordance with the present invention utilises the Bernoulli effect to provide a naturally self regulating discharge characteristic. Cold water is discharged rapidly but the discharge diminishes rapidly as the saturation temperature of the fluid is approached and flash steam is generated. Once the discharge rate exceeds the condensate load, some steam is inevitably lost, but the high flow resistance of the vortex minimises this so that at the extreme where no condensate is present, the loss is just 5% of the cold water discharge capacity of the escape aperture. In a more typical application where the hot condensate load is 60% of the capacity of the discharge escape aperture, the loss will be around 2% of the cold water capacity.

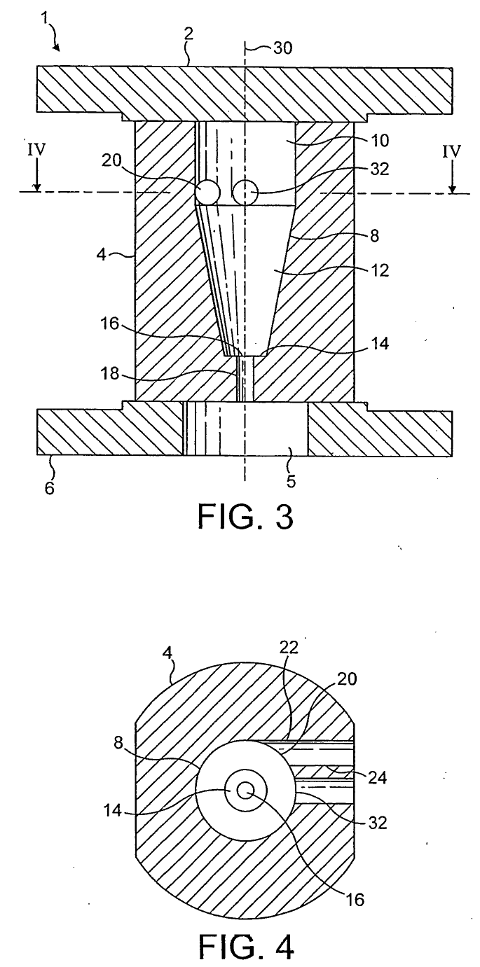

Referring now to FIG. 3, a second embodiment of the present invention is shown. Reference numerals in FIGS. 3 and 4 relate to similar features as in FIGS. 1 and 2.

The steam trap shown in FIGS. 3 and 4 is provided with a second inlet 32 which extends radially of the chamber 8 such that the second inlet 32 directs steam and condensate into the chamber 8 centrally, towards the central axis 30 of the chamber 8.

In use, a switching mechanism (not shown) is provided upstream of the trap 1, either integrally or as a separate component, and switches the flow between the first 20 and second 32 inlets. This is controlled by sensing means which determines the type of fluid in the pipeline upstream of the trap 1. This may be an electronic system, or a self actuating system which responds to temperature, for example employing a bimetallic element.

If the flow is directed to the first inlet 20, steam and condensate is introduced tangentially into the chamber 8 through the inlet 20. The steam and condensate flows around the chamber wall 8 in an anticlockwise direction, with reference to FIG. 4, creating a vortex. The centre of the vortex lies along the central axis 30 of the chamber 8. As discussed above, the low pressure volume created by the vortex upstream of the escape aperture 16 restricts the discharge through the escape aperture 16.

If the flow is directed to the second inlet 32, as the inlet 32 is directed towards the central axis of the chamber 8, no vortex is generated. The trap then acts as a conventional fixed orifice trap. The pressure upstream of the escape aperture 16 is higher than with the vortex, and the aperture is less restricted. In this way the characteristics of the flow trap can be altered according to the load. For example, if the fluid upstream of the inlets is at a low temperature then it is likely to be all, or nearly all, condensate, in which case the second inlet 20 may be used thereby avoiding the creation of a vortex in the chamber 8, and therefore preventing the associated restriction of the escape aperture 16 by the generation of flash steam. This will expel condensate as quickly as possible.

If the fluid upstream of the inlets is predominantly steam, the first inlet 20 is selected. This creates a vortex in the chamber and restricts the escape aperture 16 accordingly, therefore reducing the amount of steam lost to the environment.

In this way, the restriction of the discharge through the escape aperture can be controlled in response to the temperature of the fluid entering the trap, and an improved ratio of condensate to live steam discharge is achieved.

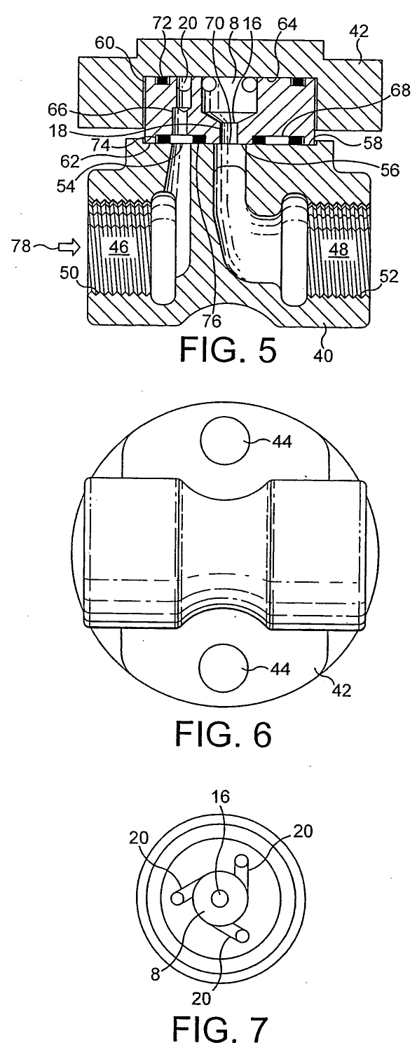

FIGS. 5 to 7 show a practical embodiment of a steam trap including a vortex chamber 8. The chamber 8 is secured to a body 40 by a cap 42 which is fastened to the body 40 by bolts 44 (FIG. 6). The body 40 comprises an inlet passage 46 and an outlet passage 48 which have aligned threaded bores 50, 52 for connection to further pipework. The passages 46, 48 extend to respective ports 54, 56 at a flat, circular contact surface 58 formed on the body 40.

The chamber 8 is formed in a control element 60 which is of generally cylindrical form having opposite axial end faces 62 and 64. The end face 62 constitutes a contact surface and abuts the contact surface 58 of the body 40. The chamber 8 opens at the face 64, and the inlets 20 are formed as grooves in the face 64. As shown in FIG. 7, there are three of the inlets 20 which are equally distributed about the chamber 8 and are directed transversely of the chamber 8.

The chamber 8 is generally cylindrical over its full length, although it has a shallow frusto conical end wall in which the escape aperture 16 is situated. In alternative embodiments, the frusto conical end wall may be replaced by a transverse, radially extending end wall.

Each inlet 20 is connected by a respective passageway 66 to a port 68 in the form of a circular groove. This groove 68 is centred on a port 70 and the end of the conduit 18 away from the escape aperture 16. The arrangement of the port 70 and the groove 68 is such that the control element 60 can be placed on the contact surface 58 in any orientation about the port 70 while maintaining communication between the inlets 20 and the escape aperture 16 and the respective inlet and outlet passages 46 and 48 by way of the ports 54 and 56. Seals 72, 74 and 76 are provided to prevent leakage at the faces 62 and 64.

The cap 42 clamps the control element 60 against the contact face 58 of the body 40. The cap 42 closes the chamber 8 and the inlets 20. In operation, steam and condensate enters the trap as indicated by an arrow 78 and passes through the inlet passage 46 to the inlets 20 by way of the port 54, a groove 68 and the passageways 66. As described above with reference to FIGS. 1 to 4, flow through the inlet 20 creates a vortex within the chamber 8 which regulates flow through the escape aperture 16. Condensate and steam passing through the passage 18 enters the outlet passage 48 by way of the ports 70 and 56, for discharge or return to the boiler.

The construction shown in FIG. 5 makes it simple to exchange one control element 60 for another without disturbing the connection between the body 40 and the surrounding pipework. Such exchange may be desirable if, for example, a control element 60 of different characteristics (for example with an escape aperture 16 of a different diameter) , or to replace a worn or damaged control element 60 for another.

1. A condensate trap comprising a vortex chamber, an inlet and a single outlet, the inlet being disposed to admit fluid into the chamber in a manner to promote a rotational flow of the fluid in the chamber about a longitudinal axis of the chamber, and the outlet comprising an escape aperture at an axial end of the chamber.

2. A condensate trap as claimed in claim 1, wherein at least a portion of the vortex chamber is cylindrical.

3. A condensate trap as claimed in claim 1 or 2, wherein at least a portion of the vortex chamber is frusto conical.

4. A condensate trap as claimed in claims 2 and 3, wherein the cylindrical portion adjoins the wider diameter end of the frusto conical portion.

5. A condensate trap as claimed in claim 4, wherein the inlet opens into the cylindrical portion.

6. A condensate trap as claimed in claims 3 to 5, wherein the escape aperture is disposed at the narrower end of the frusto conical portion.

7. A condensate trap as claimed in anyone of the preceding claims, wherein the escape aperture is situated on the longitudinal axis of the vortex chamber.

8. A condensate trap as claimed in any one of the preceding claims, wherein the escape aperture is provided in a transverse end wall of the vortex chamber.

9. A condensate trap as claimed in any one of the preceding claims, wherein the vortex chamber is provided in a control element supported by a body provided with inlet and outlet passages, the inlet passage communicating with the inlet to the chamber and the outlet passage communicating with the escape aperture.

10. A condensate trap as claimed in claim 9, wherein the control element and the body abut each other at respective contact surfaces, the inlet and outlet passages opening at respective ports on the contact surface of the body, and the inlet and escape aperture communicating with respective ports at the contact surface of the control element.

11. A condensate trap as claimed in claim 10, wherein the control element is engageable with the body in any one of a plurality of different rotational positions about the port communicating with the escape aperture.

12. A condensate trap as claimed in claim 11, wherein the port communicating with the inlet comprises a circular groove in the contact face, centred on the port communicating with the escape aperture.

13. A condensate trap as claimed in any one of claims 9 to 12, wherein the inlet is one of a plurality of inlets which are directed tangentially of the chamber and are distributed equally around the chamber.

14. A condensate trap as claimed in any one of claims 9 to 13, wherein the control element is secured to the body by a cap.

15. A condensate trap as claimed in claim 14, wherein the chamber is open at a face of the control element opposite the contact surface, the chamber being closed by the cap.

16. A condensate trap as claimed in any one of the preceding claims, further comprising a second inlet which directs the fluid towards the longitudinal axis of the chamber.

17. A condensate trap as claimed in claim 16, wherein the second inlet is provided at the same longitudinal position along the vortex chamber as the first inlet.

18. A condensate trap as claimed in claim 16 or 17, further comprising switch means to select either the first or second inlet to provide the fluid into the chamber.

19. A condensate trap as claimed in claim 18, wherein the switch means is responsive to temperature sensing means, the temperature sensing means sensing the temperature of the fluid upstream of the trap.

20. A condensate trap according to any one of the preceding claims, wherein the diameter of the escape aperture is not greater than 40 mm.

21. A condensate trap according to claim 20, wherein the diameter of the escape aperture is not greater than 30 mm.

22. A condensate trap substantially as described herein with reference to, and as shown in, FIGS. 1 and 2, or FIGS. 3 and 4, or FIGS. 5 to 7 of the accompanying drawings.

23. A steam plant provided with a condensate trap in accordance with any one of the preceding claims.

24. A method of controlling a flow of steam and condensate utilising a condensate trap in accordance with any one of the preceding claims in which method the flow of steam and condensate is directed into the vortex chamber in a direction so as to create a vortex within the chamber, the vortex having a low pressure region situated adjacent the escape aperture.

25. A method of controlling a flow of steam as claimed in claim 24 and substantially as described herein.
